(19) United States
(12) Patent Application Publication
(10) Pub. No.: US 2025/0307699 A1
(43) Pub. Date: Oct. 2, 2025

(54) AUTOMATED TRAINING DATASET MODIFICATIONS TO BALANCE DATA VARIATION

(71) Applicant: INTERNATIONAL BUSINESS MACHINES CORPORATION, ARMONK, NY (US)

(72) Inventors: JEFFREY WILLOUGHBY, POUGHKEEPSIE, NY (US); JUAN CARLOS CAMACHO MERCEDES, ELIZABETH, NJ (US); ANDREW C. M. HICKS, HIGHLAND, NY (US); EDWARD C. MCCAIN, CAMPBELL HALL, NY (US)

(21) Appl. No.: 18/624,245

(22) Filed: Apr. 2, 2024

(51) Int. Cl. G06N 20/00; G06F 18/23213

(52) U.S. Cl. CPC G06N 20/00; G06F 18/23213

(57) ABSTRACT

In a particular embodiment, providing automated training dataset modifications to balance data variation includes detecting that a confidence score associated with a machine learning prediction is below a configured threshold, wherein the machine learning prediction is based on input data applied to a machine learning model; inserting, in response to detecting that the confidence score is below the configured threshold, a data point for the input data in a review dataset; detecting, based on a pattern of data point attributes, a cluster of data points among a plurality of data points in the review dataset; and modifying, based on identifying that the cluster includes a threshold number of data points, a training dataset for the machine learning model.

### BACKGROUND

The present disclosure relates to methods, apparatus, and products for automated training dataset modifications to balance data variation. Artificial intelligence models are computational structures or algorithms designed to perform specific tasks or make decisions without being explicitly programmed for those tasks. These models are trained on data to learn patterns, relationships, and representations that enable them to make predictions, classify inputs, or generate outputs in response to new and unseen data.

### SUMMARY

According to embodiments of the present disclosure, various methods, apparatus and products for automated training dataset modifications to balance data variation are described herein. In some aspects, providing automated training dataset modifications to balance data variation includes detecting that a confidence score associated with a machine learning prediction is below a configured threshold, where the machine learning prediction is based on input data applied to a machine learning model. It also includes inserting, in response to detecting that the confidence score is below the configured threshold, a data point for the input data in a review dataset. It further includes detecting, based on a pattern of data point attributes, a cluster of data points among a plurality of data points in the review dataset. It still further includes modifying, based on identifying that the cluster includes a threshold number of data points, a training dataset for the machine learning model.

### BRIEF DESCRIPTION OF THE DRAWINGS

FIG. 1 sets forth an example computing environment according to aspects of the present disclosure.

FIG. 2 sets forth a flow chart of an example method for automated training dataset modifications to balance data variation in accordance with at least one embodiment of the present disclosure.

FIG. 3 sets forth a flow chart of another example method for automated training dataset modifications to balance data variation in accordance with at least one embodiment of the present disclosure.

FIG. 4 sets forth a flow chart of another example method for automated training dataset modifications to balance data variation in accordance with at least one embodiment of the present disclosure.

FIG. 5 sets forth a flow chart of another example method for automated training dataset modifications to balance data variation in accordance with at least one embodiment of the present disclosure.

FIG. 6 sets forth a flow chart of another example method for automated training dataset modifications to balance data variation in accordance with at least one embodiment of the present disclosure.

### DETAILED DESCRIPTION

Machine learning models make decisions in response to a particular input based on predicted probabilities that the decision is correct. For example, the input may be a sequence of text, pixel data of an image, values of input variables, and so on. Such decisions are often related to a classification task, such as classifying whether an input is valid or invalid, classifying image data as including a particular person's face, classifying textual subject matter as relating to science, politics or religion, and so on. Machine learning models are trained on very large datasets to learn patterns and relationships in the data that enable them to make these decisions. However, just like humans, machine learning models are not always confident in their predictions and decisions.

Machine learning models are composed of artificial neurons that take weighted inputs and supply an output. An activation function determines whether or not the neuron will ‘fire.’ Activation functions introduce non-linearity to the system, which makes the artificial neural network more capable of learning relationships in data. The output of the activation function is associated with a probability. For example, the probability may be a point on a sigmoid curve or a value in a SoftMax probability distribution. At the output layer of the neural network, the probability associated with the activation function determines which decision or prediction will be made by the machine learning model. For example, if the model requires a threshold probability of 0.7 and the activation function indicates a probability that an image includes a cat is 0.98, the model will predict that the image includes a cat. However, if the model is struggling to make a prediction, because perhaps the cat looks a little like a dog, the probability might drop to 0.72. Edge cases, in which the probability is only a few points higher or lower than the threshold, indicate a confidence issue that could arise from an insufficiency in the training data. For example, the training data may not have included enough images of different types of cats or simply not enough images of cats. On the other hand, the cat could just be an odd-looking cat-one that the model has never encountered before and might not encounter again. In that case, the training data may have been sufficient to accomplish the task except for these rare instances. It should be noted here that a confident prediction is distinguished from a correct prediction-a machine learning model can make an incorrect prediction confidently, and vice versa.

It is therefore important to determine whether poor performance by the model stems from insufficiency of training or is simply an edge case. For the purpose of illustration, consider an example in which a machine learning model has been trained to determine whether an error message from a computer system is valid or invalid. It will be understood that computer systems produce all sorts of error messages for human attention-some of which are valid and require human attention, and some of which may not, in actuality, require human attention. This model may make predictions as to whether an error message is valid or invalid-logging valid messages and discarding invalid messages. In some cases, the model might struggle with a particular type of error message, oscillating between marking one error message as valid and then a very similar error message as invalid. A closer look at the probabilities associated with these decisions might indicate that they are being made with low confidence (e.g., only a few points higher or lower than the activation threshold) and that particular input messages associated with low confidence predictions include very similar attributes. When low confidence predictions are repeatedly made in response to messages with these similar attributes, this could indicate an insufficiency in the training data.

Thus, as data that is input to the machine learning model varies over time, be it test data or real-world data, this data variation may necessitate a retraining of the machine learning model to enable it to better-interpret input data with unseen characteristics. This will allow the machine learning model to make predictions with more confidence and mitigate oscillation between prediction outcomes based on similar input data. However, reliance on human technicians to identify deficiencies and intervene to correct the training can be costly, time consuming, and insufficient.

Embodiments in accordance with the present disclosure address these challenges by providing an analytics module that detects machine learning predictions that are made with low confidence, saves the input data that led to the predictions as data points, clusters the data points, and modifies the training dataset based on these clusters to add new samples to the training dataset or reinforce existing samples. Thus, when the system detects, based on confidence scores, that the machine learning model is struggling with a particular pattern of input data, it reacts by retraining the model to better recognize these patterns and make more confident predictions. As input data varies over time, and new patterns in the input data emerge causing the machine learning model to struggle with its predictions, the automated process of the analytics module identifies these patterns and adjusts the training data for the machine learning model.

A particular implementation of the present disclosure is directed to a method for automated training dataset modifications to balance data variation. The method includes detecting that a confidence score associated with a machine learning prediction is below a configured threshold, where the machine learning prediction is based on input data applied to a machine learning model. The method also includes inserting, in response to detecting that the confidence score is below the configured threshold, a data point for the input data in a review dataset. The method also includes detecting, based on a pattern of data point attributes, a cluster of data points among a plurality of data points in the review dataset. The method further includes modifying, based on identifying that the cluster includes a threshold number of data points, a training dataset for the machine learning model.

In some variations, the machine learning prediction is a classification of the input data. In some variations, the confidence score is a function of a probability associated with the machine learning prediction and a minimum probability threshold. In some variations, the cluster of data points indicates a degree of similarity in the input data associated with each data point. In some variations, the method also includes retraining the machine learning model based on the modified training dataset.

In some variations, modifying, based on identifying that the cluster includes the threshold number of data points, the training dataset for the machine learning model includes adding input data associated with the cluster of data points to the training dataset for the machine learning model.

In other variations, modifying, based on identifying that the cluster includes a threshold number of data points, a training dataset for the machine learning model includes mapping the cluster of data points to one or more samples in the training dataset and increasing a weight of the one or more samples in the training dataset. In some examples of these variations, a second learning model is trained based on a reduced dataset that includes the one or more samples. Input data associated with the cluster of data points is provided to a second learning model, where the weight of the one or more samples in the training dataset is increased when the second learning model meets a performance goal. In some examples, the input data associated with the cluster of data points is added to the training dataset when the second learning model does not meet the performance goal.

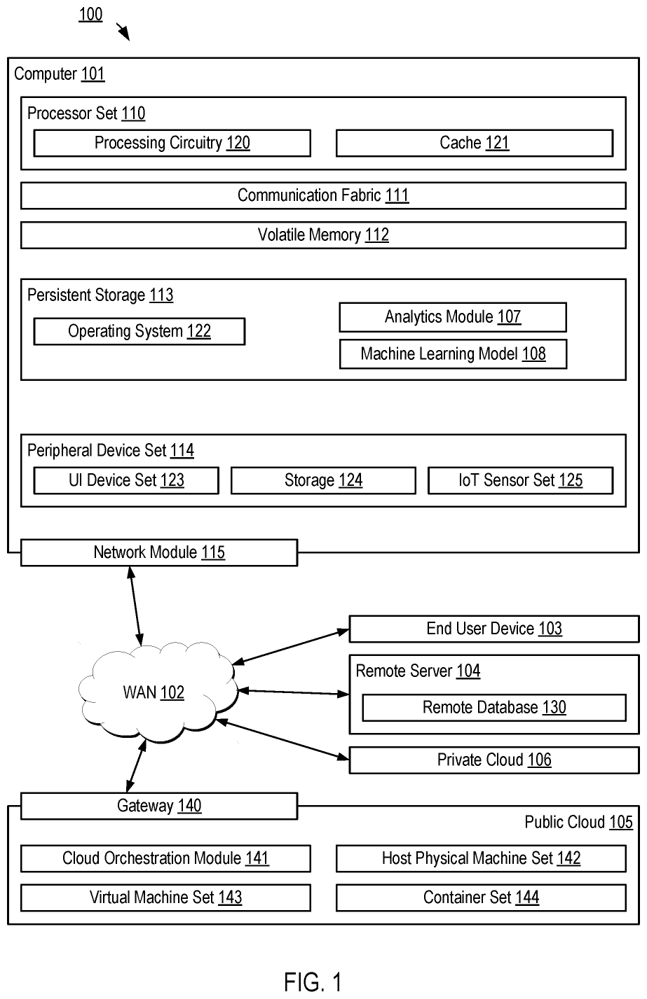

With reference now to FIG. 1, FIG. 1 sets forth an example computing environment according to aspects of the present disclosure. Computing environment 100 contains an example of an environment for the execution of at least some of the computer code involved in performing the various methods described herein, such as analytics code 107 for automated training dataset modifications to balance data variation and a machine learning model 108. In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

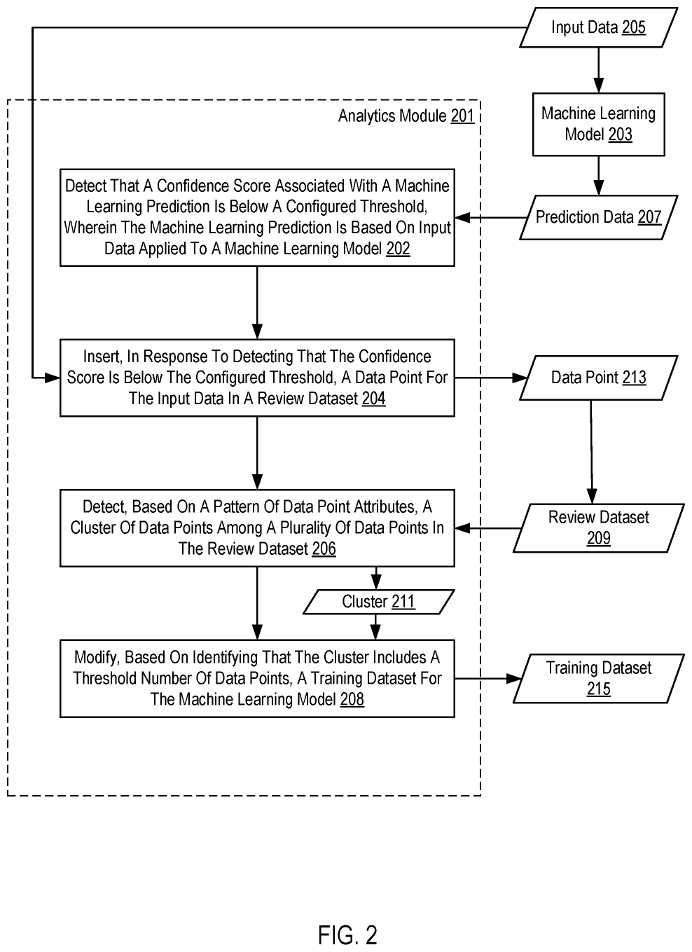

FIG. 2 sets forth a flow chart of an example method of automated training dataset modifications to balance data variation in accordance with at least one embodiment of the present disclosure. The example of FIG. 2 includes an analytics module 201. The analytics module 201 is configured to review decisions or predictions made by a machine learning model 203, assess the model's confidence, and identify what types of input data are causing the model to make unconfident decisions/predictions. The analytics module 201 is also configured to determine when and how to modify the training dataset based on these identified problem areas. The analytics module 201 may be a module of computer programming instructions that are executable by a computing system to carry out the method of FIG. 2 and the following figures. The machine learning model 203 is configured to make predictions or decisions based on input data applied to the machine learning model 203. For example, the input data can be text data, image data, variable values, and so on. In a particular example that will be referred to throughout this disclosure, the machine learning model is configured to process text data and classify the text data. For example, the text data may receive a binary classification (e.g., positive or negative sentiment, valid or invalid message, etc.) or a classification selected from some a set of classes. In some examples, the input data applied to the machine learning model 203 is test data from a training data set. In other examples, the analytics module 203 and the machine learning model are deployed in production such that the input data applied to the machine learning model 203 is non-training data, or ‘real-world’ data.

The method of FIG. 2 includes detecting 202 that a confidence score associated with a machine learning prediction is below a configured threshold, wherein the machine learning prediction is based on input data 205 applied to a machine learning model 203. As discussed above, a machine learning model includes multiple layers of artificial neurons. The inputs to a neuron are weighted and biased with the resulting sum being provided to an activation function. The activation function determines whether the neuron ‘fires’ in that its output is provided to the next layer. At the output layer, activation functions can be selected to output values that can be interpreted as probabilities. For example, the sigmoid function squashes the output into a value between 0 and 1. This value can be interpreted as a probability value. The SoftMax function outputs a distribution of probabilities across a set of classes, tokens, or other dimensions. Thus, the outcome predicted by the artificial neural network is based on a probability determined by the activation function. In some cases, a particular outcome is predicted when the probability associated with that outcome satisfies a minimum probability threshold. In other cases, an outcome is predicted based on the highest probability in a probability distribution.

Generally, a machine learning model is more ‘confident’ in its prediction when the probability associated with the activation function is higher. In accordance with embodiments of the present disclosure, a confidence function is applied to the probabilities output by the activation functions at the output layer. In some implementations, the confidence function identifies a degree of deviation from a minimum threshold needed to fire the neuron at the output layer and outputs a confidence score. For example, the confidence of the model's prediction can be defined as whether or not the outputted probability value falls between N points above and below the minimum threshold for activation, or N points above and M points below, where a probability value falling within this range is considered to be ‘not confident.’ In another example, the confidence of the model's prediction can be expressed as function of the difference between the minimum threshold, where a degree of confidence increases as this difference increases. Accordingly, the confidence score can be a binary value, a rating, or the output of a confidence function.

For purposes of illustration, consider an example where a minimum threshold for a neuron to decide whether an image includes a cat is 0.70. A confidence score for the decision is derived from the calculated probability and the minimum probability. For example, the decision as to whether the image includes a cat can be defined to be confident if the calculated probability is above 0.75 (i.e., confident that the image includes a cat) or below 0.65 (i.e., confident that the image does not include a cat). Where the calculated probability is 0.73, the decision is therefore deemed not confident. Similarly, a calculated probability that is 0.95 can be said to be very confident, resulting in a relatively high confidence score, and a calculated probability that is 0.71 can be said to be not very confident, resulting in a relatively confidence low score.

Thus, in some implementations, the analytics module 201 detects 202 that a confidence score associated with a machine learning prediction is below a configured threshold by receiving prediction data 207 including one or more activation probabilities related to the prediction. The analytics module 201 calculates a confidence score for the prediction based on one or more activation probabilities. For example, one or more activation probabilities can be the output of a sigmoid function or a SoftMax probability distribution. The confidence score is calculated based on a deviation from a minimum activation threshold as discussed above. A prediction is scored higher as the deviation from the minimum activation threshold positively or negatively increases. In some examples, the analytics model 201 includes a configurable confidence threshold parameter to detect when a confidence score for a machine learning prediction is below this threshold. When the confidence score is lower than this threshold, in that the prediction is not associated with a high degree of confidence, the analytics module recognizes as a prediction that the model ‘struggled’ to make. The confidence score threshold is configurable because different ranges of confidence scores may be acceptable in consideration of the nature or complexity of the task, the stage of model training and validation, the range and diversity of potential outcomes, and so on.

A model's ability to make confident predictions, or predictions with a threshold confidence score as defined above, stems from the robustness of its training and/or its training dataset. The analytics module 201 module is configured to recognize and correlate input data that causes the machine learning model 203 to struggle with, or make unconfident predictions on, the input data based on confidence scores. This correlated input data is indicative of a deficiency in the training or training dataset. For example, if the machine learning model confuses a cat with a dog, then it probably did not see enough cats and dogs in its training dataset.

To that end, the method of FIG. 2 also includes inserting 204, in response to detecting that the confidence score is below the configured threshold, a data point 213 for the input data 205 in a review dataset 209. In some examples, the analytics module 201 receives or retrieves the input data associated with a prediction whose prediction score is below the threshold. In some implementations, the analytics module 201 inserts 204 the data point 213 for the input data 205 in the review dataset 209 by creating a record or entry in a database or other data structure, where the record or entry includes the input data or a representation of the input data. In various implementations, the data point 213 can also include the confidence score, the activation function probability, the predicted outcome, and/or other data or attributes useful in correlating two or more occurrences of similar input data leading to a low confidence score. In some examples, the review dataset 209 consists of data points for each encounter of input data that resulted in a prediction with a confidence score below the threshold. In particular example, the input data includes a sequence of text that is input to the machine learning model for natural language processing, such as for text classification, translation, generation, and so on.

In some examples, a data point 213 is associated with an eigenvector of the input data. In an example wherein the input data 205 is a sequence of text, an eigenvector can be created to give weights to all words within the input data 205. The eigenvector is associated with the data point. After the process is repeated for many predictions associated with low confidence scores, the eigenvectors indicate certain words that tend to be within input data that results in low confidence scores, indicating that the machine learning model 203 is struggling with these words. The count of each individual vector can be increased, for example, using a dot product. The result is a set of words with which the machine learning model 203 struggles, which can be correlated to other input data that includes these words. Thus, the eigenvectors can be used to identify similarity among input data recorded in the review dataset 209.

The method of FIG. 2 also includes detecting 206, based on a pattern of data point attributes, a cluster 211 of data points among a plurality of data points in the review dataset 209. In some implementations, the analytics module 201 analyzes the set of data points in the review dataset 209 to identify reoccurring patterns where the input data in the saved data points are similar enough to reveal a trend of sample data missing from the training data set. In some examples, the analytics module 201 detects 206 a cluster 211 of data points in the review set 209 by detecting that a subset of data points share the same or similar data point attributes, thus reflecting a similarity of the input data associated with these data points. For example, two data points might be clustered together if they share similar words in their text input data, such as a similar frequency of word usage across a vocabulary, similar occurrence of weighted words, similar eigenvectors, and so on. In another example, two data points might be clustered together if they share the same variable values in their input data, or variable values within a certain range of each other. In yet another example, two data points might be clustered together based on the same prediction. For example, in a classification task, when the machine learning model repeatedly predicts the same classification with low confidence scores, the input data leading to those predictions can indicate a deficiency in the training dataset.

In some examples, the analytics module 201 clusters the data points using a clustering algorithm such as centroid-based clustering (e.g., k-means), density-based clustering, Gaussian distribution-based clustering, and so on. As mentioned above, eigenvectors can be used to unitize the data points to permit correlation and clustering based on similarities of data point attributes. It will be appreciated that other mathematical constructs that are not specifically identified in this disclosure can be used to cluster the data points. These clusters represent groups of similar input data that the machine learning model 203 has repeatedly encountered and for which the machine learning model 203 has been unable to make a confident prediction. Outliers of the clusters may indicate that the input data is an anomaly attributable to a rarity of the input data.

The method of FIG. 2 also includes modifying 208, based on identifying that the cluster 211 includes a threshold number of data points, a training dataset 215 for the machine learning model 203. Once a cluster 211 has reach a threshold number of data points, the analytics module 201 will determine that the input data associated with the cluster data points indicates a trend that demonstrates an insufficiency the training data or an application of the training data to train the machine learning model 203. In response to this determination, the analytics module 201 modifies 208 the training dataset. In some examples, modifying 208 the training dataset 215 can include focusing the training on particular samples that exist in the training dataset to increase the machine learning model's abilities to make more confident predictions, as will be discussed in more detail below. In other examples, modifying 208 the training dataset 215 can include adding the data samples based on the input data of the cluster 211 to the training dataset 215.

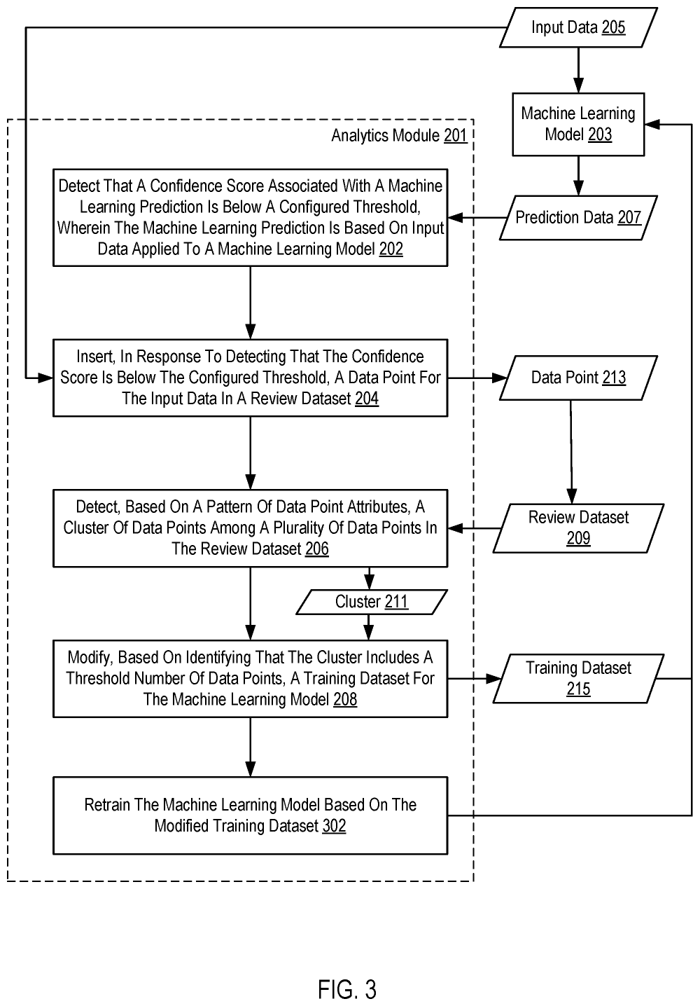

For further explanation, FIG. 3 sets forth a flow chart of another example method for automated training dataset modifications to balance data variation in accordance with at least one embodiment of the present disclosure. The method of FIG. 3 extends the method of FIG. 2 in that the method of FIG. 3 includes retraining 302 the machine learning model 203 based on the modified training dataset. In some examples, retraining 302 the machine learning model 203 includes retraining the 203 based on a reduced version of the dataset that focuses the training on particular data samples. In some examples, retraining 302 the machine learning model 203 includes retraining the machine learning model 203 based on the training dataset including the additional samples based on the input data associated with the cluster 211.

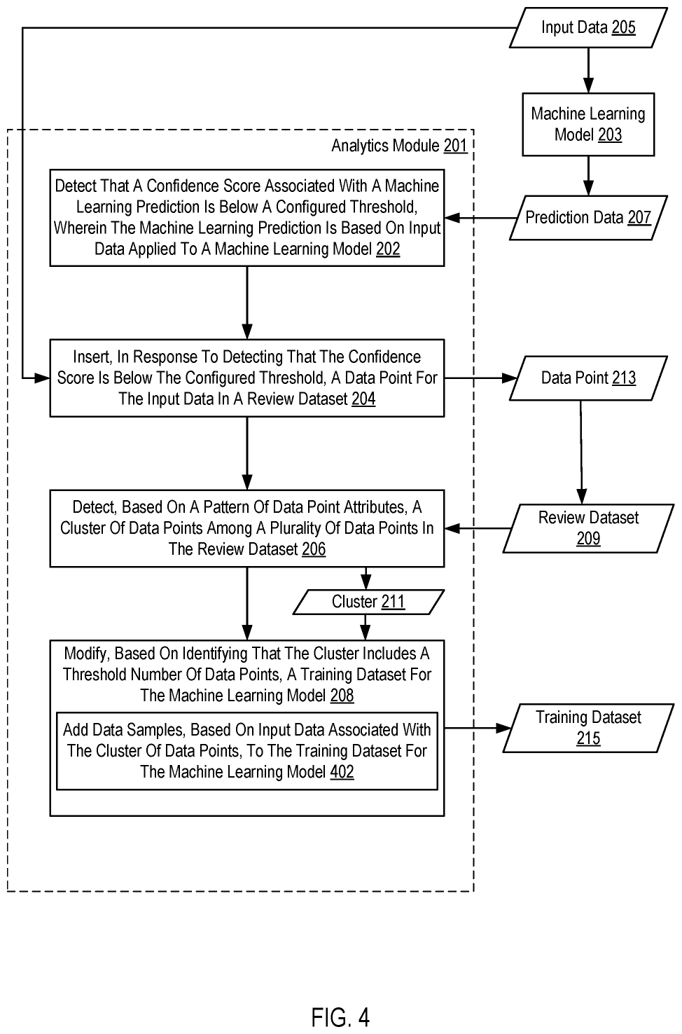

For further explanation, FIG. 4 sets forth a flow chart of another example method for automated training dataset modifications to balance data variation in accordance with at least one embodiment of the present disclosure. The method of FIG. 4 extends the method of FIG. 2 in that modifying 208, based on identifying that the cluster 211 includes a threshold number of data points, a training dataset for the machine learning model 203 includes adding 402 data samples, based on input data associated with the cluster 211 of data points, to the training dataset for the machine learning model. In some examples, the analytics module 201 outputs the input data that caused the low confidence predictions. That is, for each item of input data that is associated with a data point in the cluster 211, the input data associated with that data point is output to a data structure. A human can then assist in correctly labeling the input data in the data structure. The analytics model adds 402 the input data to the training data set by inserting data samples including the correctly-labeled input data into the training data set for retraining the machine learning model 203. Although human-assisted labeling of the input data is described, it is also contemplated that automated classification of the input data can be performed by a special-purpose classifier or by a larger, more robust AI model.

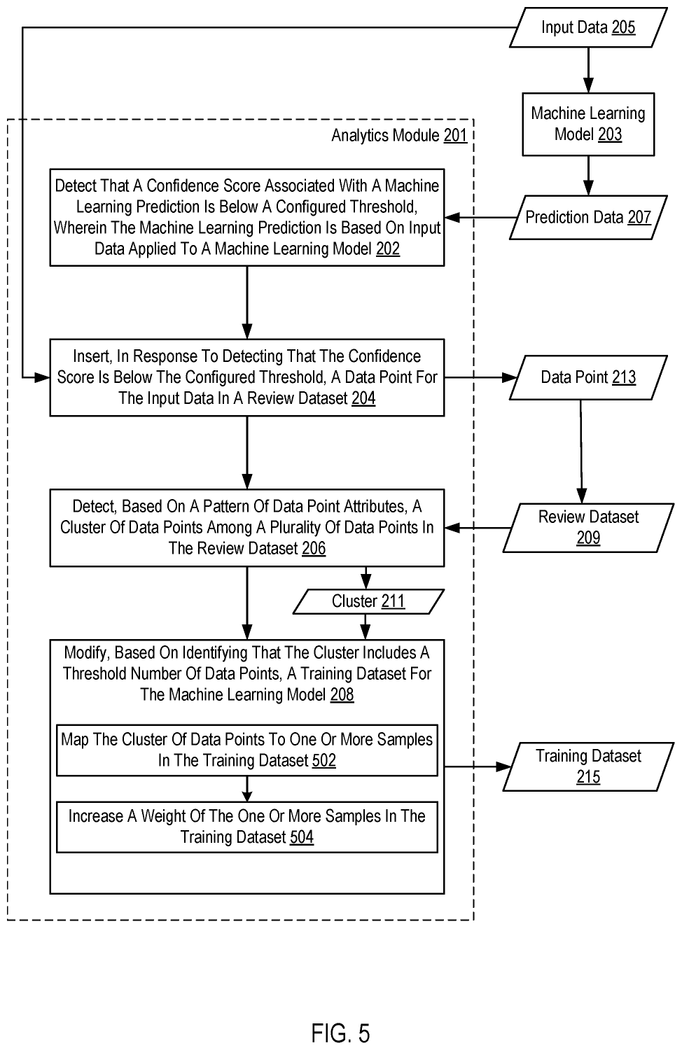

In other examples, the training dataset is modified without adding more data samples for the input data, thus obviating any requirement for human-assisted labeling of the input data. For further explanation, FIG. 5 sets forth a flow chart of another example method for automated training dataset modifications to balance data variation in accordance with at least one embodiment of the present disclosure. The method of FIG. 5 extends the method of FIG. 2 in that modifying 208, based on identifying that the cluster 211 includes a threshold number of data points, a training dataset for the machine learning model 203 includes mapping 502 the cluster 211 of data points to one or more samples in the training dataset. In some examples, the analytics module 201 maps 502 the cluster 211 of data points to one or more samples in the training dataset by identifying similarities between the data points and one or more existing data samples in the training dataset. For example, input data associated with the data points in the cluster can be correlated to a subset of the data samples in the training dataset. Similarities between the data points and the existing data samples can be identified by, for example, transforming the input data and the data samples to a vector space and computing the similarity (e.g., eigenvalues or cosine similarity). It will be appreciated that other mathematical techniques for identifying data similarity may be employed.

The method of FIG. 5 also includes increasing 504 a weight of the one or more samples. Once a subset of data samples from the training dataset has been correlated to the data points in the cluster, the machine learning model 203 can be retrained with an emphasis on this subset, thus increasing the machine learning model's ability to make a confident prediction when encountering new data that is similar to the input data associated with the cluster. In some examples, the analytics module 201 increases 504 the weight of the one or more samples by increasing the frequency that the subset of data samples appear in the training dataset. In other examples, the analytics module 201 increases the weight of the one or more samples by modifying the existing training dataset (or generating a new one) to include fewer data samples while retaining the subset of data samples correlated to the cluster, thus increasing the significance of this subset of data samples during retraining.

For purposes of illustration, consider an example where a machine learning model is trained to identify a type of animal in an image. In this example, when classifying an image as including a wolf, the machine learning model might not make a confident prediction because wolves can look like some breeds of dogs, coyotes, etc. When images of wolves are applied to the machine learning model and lead to predictions with low confidence scores, these images will be saved to the review dataset. The low confidence scores associated with images of wolves may suggest that the machine learning model was not sufficiently trained to recognize wolves. Upon analysis of the review dataset, these input images of wolves will be recognized by the analytics module as corresponding to a cluster based on the similarity of input data. The analytics module will use the images of wolves in the cluster to identify other image samples in the training dataset that also include wolves. The weight of the images of wolves in the training dataset will be increased and the machine learning model can be retrained. When the machine learning model encounters another image of a wolf, it will predict that the image includes a wolf with more confidence.

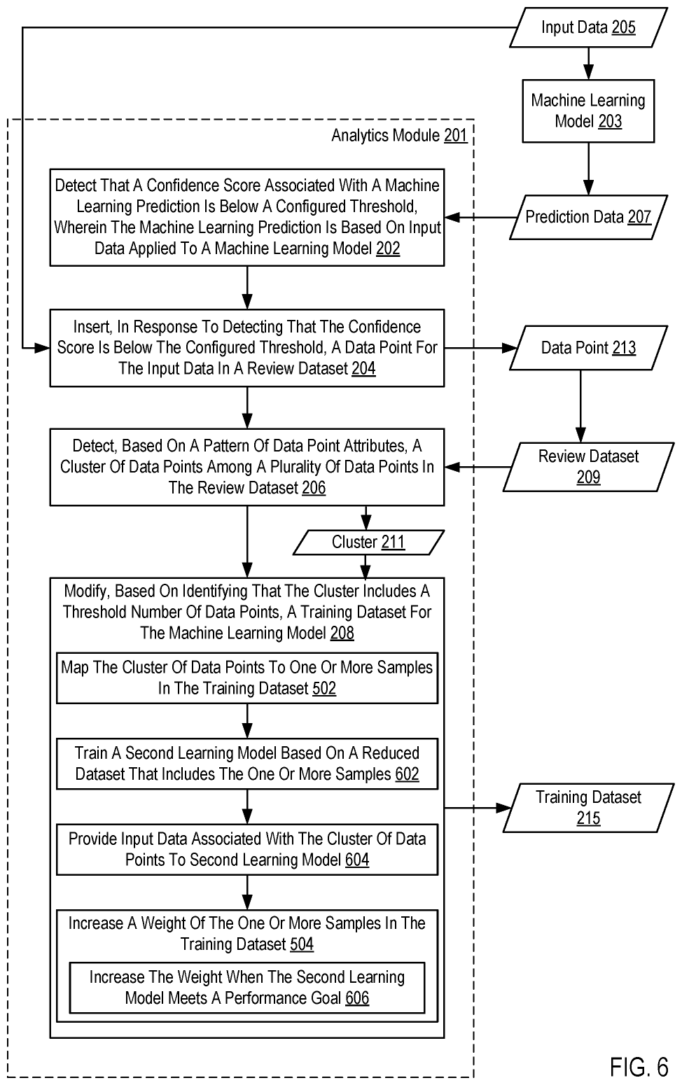

For further explanation, FIG. 6 sets forth a flow chart of another example method for automated training dataset modifications to balance data variation in accordance with at least one embodiment of the present disclosure. The method of FIG. 6 extends the method of FIG. 5 in that the method of FIG. 6 also includes training 602 a second learning model based on a reduced dataset that includes the one or more samples. In some examples, the analytics module 201 prunes the original training dataset to include fewer data samples while retaining the subset of data samples correlated to the cluster, thus increasing the proportion of the target data samples to non-target data samples in this reduced dataset. In some examples, the analytics module 201 trains a different machine learning model based on the reduced dataset. To goal is to determine whether focusing the training on these target data samples will increase the confidence and/or accuracy of the second machine learning model. In some examples, the second machine learning model is a supervised machine learning model.

The method of FIG. 6 also includes providing 604 input data associated with the cluster 211 of data points to the second machine learning model. In some examples, the analytics module 201 provides the input data as input to the second machine learning model to the trained second machine learning model. The output of the second machine learning model, including its predictions and activation probabilities associated with those predictions, is compared to the first machine learning model 203.

In the method of FIG. 6, increasing 504 the weight of the one or more samples in the training dataset includes increasing 606 the weight when the second learning model meets a performance goal. If the second machine learning model performs better than the first machine learning model 203, then the weight of the target subset of data samples is increased in the training dataset for retraining the first machine learning model 203. For example, if the second machine learning model makes a threshold number of predictions with a threshold confidence score, the analytics module 201 may determine that increasing the weight of the target subset of data samples will improve the performance of the first machine learning model 203. Thus, the input data does not need to be added to the training dataset. If the second machine learning model does not meet the performance goal, then the input data associated with the cluster of data points may be added to the original training dataset as discussed above.

For purposes of illustration, continuing the above example, the second learning model may be trained on a reduced dataset with an increased weight on pictures of wolves. The original input images that were associated with the low confidence score are then input to the second learning model. If the second learning model is able to predict that images include wolves with more confidence than the first machine learning model, this suggests that increasing the weight of images of wolves in the training dataset and retraining the first machine learning model improve the model's confidence in predicting wolves. The second learning model acts as a test case in that training the second machine learning model on the weighted data samples and assessing its performance is more efficient than retraining the first machine learning model. If the second learning model does not meet a performance goal, then it may be the case that retraining the first machine learning model will require adding labeled data samples for the input data to the training dataset as discussed above.

In view of the foregoing, embodiments of automated training dataset modifications to balance data variation in accordance with the present disclosure improve the operation of an AI and machine learning computational systems by detecting when the system is underperforming and reacting to the underperformance with an automated mechanism to modify a training dataset for the system. As data varies over time, embodiments adapt the training dataset to address training deficiencies that cause the underperformance, particularly as they relate to the confidence with which the AI/machine learning model makes predictions. Thus, the automated mechanism optimizes the data samples that are added to the training dataset. Improvements are further found in that, unlike the embodiments, a human cannot practically track and correlate input data and machine learning predictions to achieve a sufficient coverage of training data additions/modifications as input data evolves over time. Further, the embodiments are applicable to testing and training machine learning models as well as evolving already-deployed machine learning models.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting that a confidence score associated with a machine learning prediction is below a configured threshold, wherein the machine learning prediction is based on input data applied to a machine learning model;
inserting, in response to detecting that the confidence score is below the configured threshold, a data point for the input data in a review dataset;
detecting, based on a pattern of data point attributes, a cluster of data points among a plurality of data points in the review dataset; and
modifying, based on identifying that the cluster includes a threshold number of data points, a training dataset for the machine learning model.

2. The method of claim 1, wherein the machine learning prediction is a classification of the input data.

3. The method of claim 1, wherein the confidence score is a function of a probability associated with the machine learning prediction and a minimum probability threshold.

4. The method of claim 1, wherein the cluster of data points indicates a degree of similarity in the input data associated with each data point.

5. The method of claim 1 further comprising:
retraining the machine learning model based on the modified training dataset.

6. The method of claim 1, wherein modifying, based on identifying that the cluster includes a threshold number of data points, a training dataset for the machine learning model includes:
adding data samples, based on input data associated with the cluster of data points, to the training dataset for the machine learning model.

7. The method of claim 1, wherein modifying, based on identifying that the cluster includes a threshold number of data points, a training dataset for the machine learning model includes:
mapping the cluster of data points to one or more samples in the training dataset; and
increasing a weight of the one or more samples in the training dataset.

8. The method of claim 7 further comprising:
training a second learning model based on a reduced dataset that includes the one or more samples; and
providing input data associated with the cluster of data points to the second learning model,
wherein increasing the weight of the one or more samples in the training dataset includes:
increasing the weight when the second learning model meets a performance goal.

9. The method of claim 8, wherein the input data associated with the cluster of data points is added to the training dataset when the second learning model does not meet the performance goal.

10. An apparatus comprising:
a processing device; and
memory operatively coupled to the processing device, wherein the memory stores computer program instructions that, when executed, cause the processing device to:
detect that a confidence score associated with a machine learning prediction is below a configured threshold, wherein the machine learning prediction is based on input data applied to a machine learning model;
insert, in response to detecting that the confidence score is below the configured threshold, a data point for the input data in a review dataset;
detect, based on a pattern of data point attributes, a cluster of data points among a plurality of data points in the review dataset; and
modify, based on identifying that the cluster includes a threshold number of data points, a training dataset for the machine learning model.

11. The apparatus of claim 10, wherein the computer program instructions, when executed, cause the processing device to:
retrain the machine learning model based on the modified training dataset.

12. The apparatus of claim 10, wherein to modify, based on identifying that the cluster includes the threshold number of data points, the training dataset for the machine learning model, the computer program instructions, when executed, cause the processing device to:
add data samples, based on input data associated with the cluster of data points, to the training dataset for the machine learning model.

13. The apparatus of claim 10, wherein to modify, based on identifying that the cluster includes the threshold number of data points, the training dataset for the machine learning model, the computer program instructions, when executed, cause the processing device to:
map the cluster of data points to one or more samples in the training dataset; and
increase a weight of the one or more samples in the training dataset.

14. The apparatus of claim 13, wherein the computer program instructions, when executed, cause the processing device to:
train a second learning model based on a reduced dataset that includes the one or more samples; and
provide input data associated with the cluster of data points to the second learning model, wherein increasing the weight of the one or more samples in the training dataset includes increasing the weight when the second learning model meets a performance goal.

15. The method of claim 1, wherein the confidence score is a function of a probability associated with the machine learning prediction and a minimum probability threshold.

16. A computer program product comprising a computer readable storage medium, wherein the computer readable storage medium comprises computer program instructions that, when executed:
detect that a confidence score associated with a machine learning prediction is below a configured threshold, wherein the machine learning prediction is based on input data applied to a machine learning model;
insert, in response to detecting that the confidence score is below the configured threshold, a data point for the input data in a review dataset;
detect, based on a pattern of data point attributes, a cluster of data points among a plurality of data points in the review dataset; and
modify, based on identifying that the cluster includes a threshold number of data points, a training dataset for the machine learning model.

17. The computer program product of claim 16, wherein the computer program instructions, when executed:
retrain the machine learning model based on the modified training dataset.

18. The computer program product of claim 16, wherein to modify, based on identifying that the cluster includes the threshold number of data points, the training dataset for the machine learning model, the computer program instructions, when executed:
add data samples, based on input data associated with the cluster of data points, to the training dataset for the machine learning model.

19. The computer program product of claim 16, wherein to modify, based on identifying that the cluster includes the threshold number of data points, the training dataset for the machine learning model, the computer program instructions, when executed:
map the cluster of data points to one or more samples in the training dataset; and
increase a weight of the one or more samples in the training dataset.

20. The computer program product of claim 19, wherein the computer program instructions, when executed:
train a second learning model based on a reduced dataset that includes the one or more samples; and
provide input data associated with the cluster of data points to the second learning model, wherein increasing the weight of the one or more samples in the training dataset includes increasing the weight when the second learning model meets a performance goal.
